(19) United States
(12) Patent Application Publication
(10) Pub. No.: US 2025/0019296 A1
(43) Pub. Date: Jan. 16, 2025

(54) IMPROVEMENT OF GLASS STRENGTH AND FRACTURE TOUGHNESS BY A NON-BRITTLE COATING

(71) Applicant: EXXERGY GmbH, Gräfelfing (DE)

(72) Inventors: Bulent Yoldas, Gräfelfing (DE); John Brown, Gräfelfing (DE); Thomas C. Sauer, Gräfelfing (DE)

(21) Appl. No.: 18/708,867

(22) PCT Filed: Aug. 4, 2022
(86) PCT No.: PCT/EP2022/071979

§ 371 Date: May 9, 2024

(30) Foreign Application Priority Data
Nov. 10, 2021 (DE) 10 2021 129 250.6

(51) Int. Cl. C03C 17/30; C03C 17/00

(52) U.S. Cl. CPC C03C 17/30; C03C 17/002; C03C 2217/78; C03C 2218/111; C03C 2218/112; C03C 2218/153; C03C 2218/31; C03C 2218/32

(57) ABSTRACT

The present invention relates to the a coating and the preparation thereof for improving glass strength and fracture toughness comprising the hydrolytic polycondensation product of one or more alkoxysilane(s) with one or more metal oxide(s) and/or metal alkoxide(s) in the presence of water and a catalyst. The present invention also relates to the use of the coating for repairing damaged silica containing materials.

### FIELD OF THE INVENTION

The present invention generally relates to methods and systems for improving glass strength and fracture toughness of glass or for repairing damaged glass or any silica containing material. In particular, the present invention relates to the use of a coating for these purposes comprising the hydrolytic polycondensation product of one or more alkoxysilane(s) with one or more metal or metalloid oxide(s) and/or metal or metalloid alkoxide(s) in the presence of water and a catalyst.

### BACKGROUND

Glass strength drops drastically after glass is exposed to atmospheric moisture (for example in moderate climates down to 77 ppm (0,1 g/Nm³ equivalent to 20% relative humidity at −30° C.) in extreme cold and dry winter weather and up to 90,000 ppm (115 g/Nm³ equivalent to 100% humidity at +60° C.) in extreme humid summer weather) and to high forming temperatures where water or hydroxyls are chemically active and break Si—O—Si bonds by creating two terminating Si—OH bonds, weakening the structure and setting up the mechanism that finds hydroxyls at the crack tip of all cracks studied and drives these cracks to eventual breakage. The above behavior is attributed to the presence of surface micro cracks, created within a very short time (e.g. within milliseconds or seconds) during high temperature forming and propagation of cracks assisted by the atmospheric humidity.

Industry uses various methods to improve glass strength, including ion exchange (chemical tempering), thermal tempering, lamination, etc. All these methods have various shortcomings and limitations. For example, widely used methods of ion exchange, and thermal tempering do not work below certain glass thicknesses and have compositional restrictions.

By healing the defects that were created by cooling glass from forming (molten glass temperatures) to rapidly cooling to room—or largely below T_{g}, the glass transition temperature (rigid glass temperatures)—, thereby setting up tremendous stresses between the “outer” surface and the rapidly shrinking interior transgressing from liquid to “solid” state towards equilibrium (ambient) temperatures, these stresses are released by creating micro surface cracks that are initiated by such stresses, and the present water molecules in the ambient air are the main source of crack propagation, all these effects reducing the strength of glass products by up to 200-fold, or in other words, down from 100% theoretical mechanical strength to an actual approximate 0.5% of the theoretical mechanical strength.

The three traditional methods of creating a protective compressive layer depend upon some physical thickness of the glass where the compressive layer is developed. As glass is made thinner, the boundary where compressive layers are meaningful is passed. Cover glass had been 0.7 mm but is heading towards 0.4 and even 0.2 mm. These decreasing thicknesses are approaching the limit of usefulness of ion exchange. In addition, in the example of smartphones, e.g. iPhones, the electronics are printed on a special glass that is devoid of alkalis. It is precisely the alkalis, that is for example, but not limited to, lithium, sodium, and potassium, that are the major players in chemical tempering. These same ions, however, will attack the transistors, liquid crystals and electronics that are required for large flat screen displays. Regular, typical flat glass single sheet substrates (typically soda-lime or boro-silicate) are traditionally produced with thicknesses from 3 mm to 15 mm, however, with a declining trend towards less than 3 mm. For flat glasses with a thickness of 2 mm or less, tempering is coming to its physical limits, e.g. glasses of less than 3 mm can hardly be tempered as ESG, therefore, for thinner glasses down to 2 mm thickness, TVG is the traditional tempering grade possible.

Inorganic coatings are by nature brittle and eventually tend to develop their own micro-cracks in use. Non-brittle organic coatings, on the other hand, tend to be soft and therefore subject to optical deterioration by abrasion in use. To-date, no commercially available coating has the capability to create covalent bonds with the glass matrix by cracking the hydroxyl-groups (OH) on the glass surface enabling a bridge towards an O—Si—O (or other) covalent bonding, thus healing defects. It is extremely difficult to combine hardness with non-brittleness in the same material. Thus, there is a need of a coating that heals glass surfaces from the flaws introduced in high temperature forming by improving the strength of glass products and simultaneously provide sufficient abrasion resistance.

### SUMMARY OF THE INVENTION

In a first aspect provided herein is a method for preparing coatings for improving glass strength and fracture toughness of glass, the method comprises mixing
a) a composition comprising 5-95 wt. % of one or more alkoxysilane(s) of the general formula

RₓSi(OR¹)₄₋ₓ
with up to 40 wt. % one or more metal or metalloid oxide(s) and/or one or more metal or metalloid alkoxide(s) in the presence of up to 20 wt. % water and up to 95 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. % each.

In a second aspect provided herein is a method for preparing coatings for improving glass strength and fracture toughness of glass, the method comprises mixing
a) a composition comprising of up to 25 wt. % of one or more metal or metalloid oxide(s) and/or one or more metal or metalloid alkoxide(s) in the presence of up to 20 wt. % water and 60-95 wt. % of an alcohol;
b) a composition comprising 5-95 wt. % of one or more alkoxysilane(s) of the general formula

RₓSi(OR¹)₄₋ₓ
wherein R is an organic radical, R¹ is independently selected from hydrogen and C₁₋₁₈ alkyl, or isomers or polyvalences thereof, and x is an integer from 0 to 3, 5-70 wt. % of an alcohol, up to 20 wt. % water and up to 0.5 wt. % of a catalyst; and
c) a composition comprising 10-50 wt. % one or more metal or metalloid oxide(s) and/or one or more metal or metalloid alkoxide(s), 10-90 wt. % water and up to 100 wt. % of an alcohol;

wherein the weight percentage of a), b), c) and the mixture thereof, respectively, adds up to 100 wt. %.

In one embodiment of the present invention the catalyst is nitric acid, aqua regia or hydrofluoric acid or a combination thereof.

In one embodiment of the present invention R is selected from C₁₋₁₈ alkyl, C₁₋₁₈ heteroalkyl, C₁₋₁₈ alkoxy, C₂₋₁₈ alkene, phenyl, R²—(CH₂)ₙ—, cycloalkyl and aryl groups, and R²—O—(CH₂)ₙ, or isomers or polyvalences thereof; R¹ is a C₁₋₁₈ alkyl or cycloalkyl, or isomers or polyvalences thereof; R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

In a further embodiment of the present invention the one or more alkoxysilane(s) is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

In a further embodiment of the present invention the one or more metal or metalloid oxide(s) and/or the one or more metal or metalloid alkoxide(s) are selected from oxides and/or alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, or even other species.

In a further embodiment of the present invention the alkoxysilane is β-glycidoxypropyltrimethoxysilane or γ-glycidoxypropyltrimethoxysilane and the metal alkoxide is selected from boron alkoxides, titanium alkoxides and silicon alkoxides or mixtures thereof.

In a third aspect, the present invention is directed to a coating prepare by the method provided herein.

In a fourth aspect the present invention is directed to a coating comprising a mixture of
a) a composition comprising 50-85 wt. % of one or more alkoxysilane(s) of the general formula

RₓSi(OR¹)₄₋ₓ
with up to 35 wt. % one or more metal or metalloid oxide(s) and/or one or more metal or metalloid alkoxide(s) in the presence of up to 10 wt. % water and up to 30 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

In a fifth aspect, the present invention is directed to the use of the coating provided herein for improving glass strength and fracture toughness of glass, wherein glass strength and fracture toughness is improved by healing cracks in the surface of the glass.

In a sixth aspect, the present invention is directed to the use of the coating provided herein for repairing damaged silica containing material, including but not limited to any glass.

In one embodiment the present invention is directed to the use provided herein, wherein the silica containing materials comprise glass, ceramic, glass ceramic, quartz, cement and concrete.

In one embodiment the present invention is directed to the use provided herein, wherein one or more further coatings are applied for improving abrasion-resistance, chemical resistance, birefringence, modification of the index of refraction, increase hardness, protection of photovoltaic or semiconductor devices from potential induced degradation, control of increase in mechanical strength, repelling water by improving hydrophobicity, improving oliphobicity, protection against staining, weathering and/or harm deriving from energy release at the breakage force point.

In a further embodiment the present invention is directed to the use provided herein, wherein the one or more coatings are applied by dip coating, spray coating, vapor deposition, nebulizing, plasma outside deposition, chemical vapor deposition, plasma induced vapor deposition, soakage, soaking, suspension, and/or plasma enhanced vapor deposition.

In a further embodiment the present invention is directed to the use provided herein, wherein the one or more coatings are applied in a controlled atmosphere by pressures below or above atmospheric pressure and/or at temperatures above or below atmospheric temperature.

In a further embodiment the present invention is directed to the use provided herein, wherein the controlled atmosphere comprises conditioned air with a dew point below −20° C. (253 K), at or below −50° C. (223 K), at or below −78.5° C. (194,7 K), at or below −195,8° C. (77,35 K), at or below 27 K, or at 4 K.

In a further embodiment the present invention is directed to the use provided herein, wherein the controlled atmosphere comprises an industrial or specialty gas.

In a further embodiment the present invention is directed to the use provided herein, wherein the pressure during any of the processes involved in subject invention comprises a pressure up to ambient pressure, an absolute pressure of up to 950 hPa, below 500 hPa, below 100 hPa, below 10 hPa, below 1 hPa, below 0.1 Pa, less than 10-6 Pa, or even less than 10-9 Pa.

In a further embodiment the present invention is directed to the use provided herein, wherein unused coating is removed from the glass surface.

In a further embodiment the present invention is directed to the use provided herein, wherein the unused coating is removed by dipping the coated glass into or rinsing the coated glass with a solvent.

In a further embodiment the present invention is directed to the use provided herein, wherein the improvement in glass strength is between 50 to 5000%, above 5000% or above 10000%.

In a further embodiment the present invention is directed to the use provided herein, wherein devitrification is avoided.

In a further embodiment the present invention is directed to the use provided herein, wherein the damage is induced by physical and/or by chemical impact.

In a further embodiment the present invention is directed to the use provided herein, wherein prior to applying the coating the glass surface, optionally including the edges, is pretreated with fluoric acid, with mechanical edge grinding, with flame polishing, with laser treatment and/or with any other edge treatment technology.

In a further embodiment the present invention is directed to the use provided herein, wherein prior to applying the coating the glass is exposed to a temperature of at least 300 K below the transformation temperature (T_{g}).

In a further embodiment the present invention is directed to the use provided herein, wherein a temperature of at least 30° C. is applied to the coated glass or the coated silica containing material for curing.

In a further embodiment the present invention is directed to the use provided herein, wherein the coated glass or the coated silica containing material is exposed to waves of suitable frequency and/or wavelength comprising subsonic, sonic, supersonic, infrared, visible range, ultraviolet range, extreme ultraviolet range, and/or lower wavelengths than extreme ultraviolet range, and/or any other suitable frequency and/or wavelength triggering the desired reaction between the reacting partners depending on the physical properties, either frequency to enable curing of the coating to the glass substrate the silica containing material.

In a further embodiment the present invention is directed to the use provided herein, wherein the glass or the coated silica containing material is exposed to tempering prior to or after coating.

In one embodiment, the present invention is directed to the use of the coating provided herein, wherein the silica containing material is in the form of a porous material or powder that is soaked with the coating partly or entirely throughout the pores or within the powder cluster.

In a seventh aspect the present invention is directed to a glass product or product made from silica containing material prepared by the use described herein.

In a further embodiment, new bottles (containers) or returnable bottles (containers) with physical or chemical surface damage can be healed by prepared by any selected uses described herein so that such bottles can be re-used for at least one (1) further cycle, such as for example another 5 cycles or 10 cycles or even more cycles.

### BRIEF DESCRIPTION OF THE DRAWINGS

FIG. 1a shows the reaction scheme for a specific alkoxysilane with water in the presence of an acid catalyst;

FIG. 1b shows the reaction of the reaction product of FIG. 1a with a specific titanium alkoxide;

FIG. 2 is a schematic representation of chemical bonding of the inventive coating on a glass surface (a) and a schematic representation of the immobilization of sodium ions by boron coordination change (b);

FIG. 3 shows strength distribution curves of uncoated and coated samples;

FIG. 4 shows graphs indicating that the strength of float glass samples increases when the tin and air surfaces are coated as measured by “cone cracking load” technique.

FIG. 5a shows a fracture pattern of uncoated glass;

FIG. 5b shows an exemplary fracture pattern of glass coated according to the invention;

FIG. 6 shows sodium leach from coated and uncoated glass, the coating containing boron;

FIG. 7 shows a sample of a glass produced entirely by using the inventive sol gel process;

FIG. 8 shows glass damaged by a Vickers imprint test-different illumination under the microscope;

FIG. 9 shows Vickers imprint sample images without coating (left) and with coating (far right), and average breakage test results;

FIG. 10 is a surface analysis of Vickers imprint on a float glass sample;

FIG. 11 shows values for the breakage tests (1) for uncoated glass without mechanically induced defects, (2) for uncoated glass with mechanically induced defects, and (3) for glass samples with mechanically induced defects that has been coated after the application of the defects.

### DETAILED DESCRIPTION

The present invention provides a sol-gel composition in the form of a coating as provided herein that is an organic-inorganic polymer that transforms to a true glass amorphous network healing the flaws introduced by rapid cooling and differential expansion. In particular, the present invention is directed to a method for preparing coatings for improving glass strength and fracture toughness of glass, the method comprises mixing
a) a composition comprising 5-95 wt. % of one or more alkoxysilane(s) of the general formula

RₓSi(OR¹)₄₋ₓ
with up to 40 wt. % one or more metal or metalloid oxide(s) and/or one or more metal or metalloid alkoxide(s) in the presence of up to 20 wt. % water and up to 95 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

In one embodiment, the method comprises mixing
a) a composition comprising 20-80 wt. % of one or more alkoxysilane(s) of the general formula

RₓSi(OR¹)₄₋ₓ

with up to 30 wt. % one or more metal or metalloid oxide(s) and/or one or more metal or metalloid alkoxide(s) in the presence of up to 15 wt. % water and up to 50 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 30-100 wt. % of one or more metal or metalloid oxide(s) and/or one or more metal or metalloid alkoxide(s), up to 60 wt. % of an alcohol, up to 10 wt. % water and up to 1 wt. % of a catalyst; and
c) a composition comprising up to 30 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

In a still further embodiment, the method comprises mixing
a) a composition comprising 50-80 wt. % of one or more alkoxysilane(s) of the general formula

RₓSi(OR¹)₄₋ₓ
with up to 25 wt. % one or more metal or metalloid oxide(s) and/or one or more metal or metalloid alkoxide(s) in the presence of up to 10 wt. % water and up to 40 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 40-100 wt. % of one or more metal or metalloid oxide(s) and/or one or more metal or metalloid alkoxide(s), up to 50 wt. % of an alcohol, up to 10 wt. % water and up to 1 wt. % of a catalyst; and
c) a composition comprising up to 25 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

In a still further embodiment, the method comprises mixing
a) a composition comprising 60-75 wt. % of one or more alkoxysilane(s) of the general formula

RₓSi(OR¹)₄₋ₓ
with up to 20 wt. % one or more metal or metalloid oxide(s) and/or one or more metal or metalloid alkoxide(s) in the presence of 5-10 wt. % water and up to 30 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 50-100 wt. % of one or more metal or metalloid oxide(s) and/or one or more metal or metalloid alkoxide(s), up to 40 wt. % of an alcohol, up to 5 wt. % water and up to 1 wt. % of a catalyst; and
c) a composition comprising up to 20 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

The individual absolute weight of compositions a), b), and c) result in a total combined weight, with the relative weights of a)+b)+c) being 100%, the share of a), b), and c), respectively individually typically range for a) from 20 to 70 wt. %, for b) from 5 to 40 wt. %, and for c) from 0 to 50%. In one embodiment of the invention, the compositions are used in a ratio of 30-65 wt. % of composition a), 5-35 wt. % of composition b) and up to 50 wt. % of composition c). For example, the compositions are used in a ratio of 40-65 wt. % of composition a), 10-35 wt. % of composition b) and up to 50 wt. % of composition c). In another embodiment, the compositions are used in a ratio of 40-45 wt. % of composition a), 10-15 wt. % of composition b) and 10-50 wt. % of composition c). The sum of the amount of compositions a), b) and c) adds up to 100 wt. %.

This invention recognizes that glass strength deteriorates drastically immediately coming into contact with moisture containing air at forming temperatures and when water is chemically active forming chemical bonds with glass by breaking Si—O—Si and forming Si—OH terminating bonds that are weak points in the surface structure, and by handling forcing the creation of surface micro cracks. The known and practiced glass strengthening methods function by creating a compressive surface layer that must be exceeded before a break can occur. The present invention describes the first method to truly heal surface defects, the creation thereof is common to all glass produced in the past 5,000 years. The use of the coating provided herein improves glass strength and fracture toughness significantly. The coating covalently bonds to the surface of the glass upon application, eradicating existing surface micro-cracks, and their formation in the future, as well as circumventing the strength deterioration due to handling and atmospheric moisture. As the surface cracks or defects are small, e.g. having a diameter in the micrometer scale, or the nanometer scale, or even smaller, after the coating has penetrated the surface flaws it can be removed with solvents prior to thermal curing, leaving the surface as pristine as new glass, but the micro flaw retains enough of the polymer to convert to glass in curing and healing the surface defect, i.e. to be integrated into the glass matrix by the formation of covalent bonds between the one or more coatings and the glass material. Thus, without wishing to be bound by theory, covalent bonds between the coating and the glass may be created by way of chemical reaction by cracking the (terminating) hydroxyl-groups (OH—) on the glass surface enabling a bridge towards an [—O—Si—] covalent bonding or any other covalent bonding. In other words, terminating hydroxyl groups of the uncoated glass surface are cracked by chemical reaction with the one or more coatings and covalent bonds between the reactant part of the one or more coatings and the oxygen atoms on the glass surface resulting from the cracking of the hydroxyl groups are formed. Any of the inventive coatings (coating solutions) penetrate the micro-cracks on the glass surface and attach to the terminating hydroxyl groups of the glass matrix, and in the next steps, these hydroxyl groups are cracked, and a new chemical covalent bond is created. Furthermore, the coating has the surprising properties of being non-brittle (does not develop own surface cracks) yet being virtually as hard and abrasion resistant as the unaltered glass surface. Thus, the use of the coating, i.e. of the hybrid co-polymer (polymer of organic and inorganic elements), provides hardness maximized with sufficient ductility to prevent crack propagation. The coating has the additional benefit of being soluble to facilitate coating and being cured.

One limiting factor in creating true glass is the liquidus temperature, that point in cooling where the first crystal is formed, or upon heating the last crystal goes into solution. Of the periodic chart and list of metal oxides that can be used to produce glass, there is a tremendous limitation in quantity of these metal oxides that will form viable glasses without devitrification (i.e. without crystalizing). The present invention introduces a vast increase in the availability and concentration of metal oxides that can be incorporated into thin films or into bulk glass products. As conversion to true amorphous glass occurs below 500° C., this is lower than the temperatures where one is concerned for devitrification. The new materials can create glasses of extremely high Index of refraction, or other physical properties that have never been available previously to scientists working with true inorganic glasses. An example can be taken from FIG. 7, wherein the left glass is an alumina sol-gel with 64% voids, but under 50 Å diameter (right sample dipped with Isopropyl alcohol to give more transparency, picture taken directly after dipping-ethanol even better because of smaller molecule size). Thus, with the present invention devitrification is avoided or even excluded. This sample has been produced entirely by using the sol gel process without coating. However, it shows that the formulations can be used to produce coatings with very high Al₂O₃ content which is not possible through regular glass melting processes as it would devitrify or crystallize.

With the present invention it is possible to increase the functionality and versatility of glass to the point that other materials can be replaced. As an example, by virtue of the increased mechanical strength of glass, the wall thickness of container glass can be largely reduced, and with that, the weight, resulting in significant carbon footprint reduction as the amount of energy to produce a container is substantially reduced. The reduction of weight also contributes to the possibility that plastic bottles—that are populating and polluting our planet—can possibly become obsolete or at least be replaced to a large extent. In addition, the productivity of glass furnace largely increases as more containers per unit of glass melting area could be produced.

In a further embodiment, prior to applying the coating, the surface of the glass substrate is treated with hydrofluoric acid to remove a first layer of the glass surface, thus reducing the deepness of the microcracks and removing part of the terminating Si—OH bonds. In this embodiment, the coating that is applied after this treatment will result in improved effectiveness of crack penetration, and hence, in further improved increase in mechanical strength.

With the present invention, any of the above or described herein is also suitable for a silica containing material defined below.

In one aspect of the present invention, it is also possible to repair damaged silica containing materials. Such silica containing material may be, but are not limited to, glass, ceramic, glass ceramic, quartz, cement and concrete. The silica containing materials may be in any suitable form, such as, but not limited to, solid form, compressed or sintered powders, or porous materials. In a preferred embodiment the silicon containing material is glass. In the process or repairing such silica containing materials, cracks and/or damages on the surface or—having any egress to the surface—materially into the depth of the silica containing material can be repaired using the inventive coating described herein, so that the glass regains at least most of its previous properties, such as glass strength and fracture toughness, or these properties are even improved. With the present invention, for example, damages induced by physical and/or chemical impact can be repaired. Non-limiting examples of such damages are, e.g. fractures occurring due to impact of hail balls, gravel, rocks, stones or impacts by other physical objects, temperature differential impact, fatigue failure e.g. from alternating stresses, or any other physical impact on glass, windows, photovoltaic panels, car glass (e.g. windshields), container glass, tubular glass, crystal glass, tableware glass, heat-resistant glass, glass ceramics, optical glass, or any other glass substrates, quartz substrates, ceramic substrates, or cement or concreate containing substrates. In another aspect of this invention, the surface damages occurring during the various cycles of use of returnable bottles (containers), such surface defects can be healed such that the original mechanical strength of the bottles (containers) can be restored by healing the surface defects by applying the present invention. Damages induced by any other impact are also encompassed by the present invention.

As mentioned above, upon applying—and if required—curing the inventive coating, the properties of the damaged silica containing material can largely, nearly completely or completely be restored. For example, the mechanical strength of glass can be restored by at least 50% relative to the remaining mechanical strength of the previously damaged glass, such as by at least 60%, by at least 75%, by at least 80%, by at least 90%, by 100% or even by more than 100%. The same holds true for other silica containing materials.

With the coating of the present invention damaged silica containing materials can be repaired within the limits of visibility to the naked eye and/or even within the visibility of an enlargement device, such as a microscope or the like.

In a first step of the inventive method, composition a) is prepared by mixing the components in a suitable vessel. The alkoxysilane compound is partially hydrolyzed using an catalyst in the presence of water. The water in this step and all other steps of the inventive method may be any water, such as de-ionized water, distilled water, multiple distilled water, e.g. so called “bi-distilled” water, heavy water or the like. At most stoichiometric amounts of water are used, for example one mol water per mol reactive group. The catalyst may be selected from any catalyst suitable for these kind of chemical reactions. In the present invention the catalyst may be consumed during the reaction. For example, the catalyst encompasses a (chemical reaction) trigger or an acid, such as, but not limited to, nitric acid, aqua regia, hydrochloride acid, sulfuric acid or the like, and mixtures thereof. In a preferred embodiment the catalyst is nitric acid or aqua regia or hydrofluoric acid or a combination thereof.

This reaction leads to formation of hydroxyl groups to be reacted with one or more metal or metalloid oxide(s) and/or metal or metalloid alkoxide(s) and/or a silane.

The hydrolysis reaction must be given enough time to use up all water introduced into the system, i.e. that no free water remains in the solution for the next reaction step. This reaction consumes all the added water within a short time and creates terminal hydroxyl bonds. Excessive time between the two reactions should be avoided as otherwise the hydrolyzed alkoxysilane will slowly self-polymerize detrimentally affecting homogeneity. According to one embodiment of the invention, the reaction time between the alkoxysilane and water may be less than 60 minutes, such as less than 30 minutes, such as less than 20 minutes, less than 15 minutes, less than 10 minutes, less than 5 minutes, or even less than 1 minute. For example, the reaction time may be between 5 to 10 minutes, such as 6 to 10 minutes, or 8 to 10 minutes. In one embodiment the reaction time is less than 10 minutes. In a further embodiment, composition a) may be left to stand overnight.

Generally, step a) may be carried out at environmental conditions, such as at room temperature. In a preferred embodiment, step a) may be carried out under an controlled atmosphere, such as a water vapor free atmosphere, an oxygen free atmosphere, or an inert atmosphere as described below.

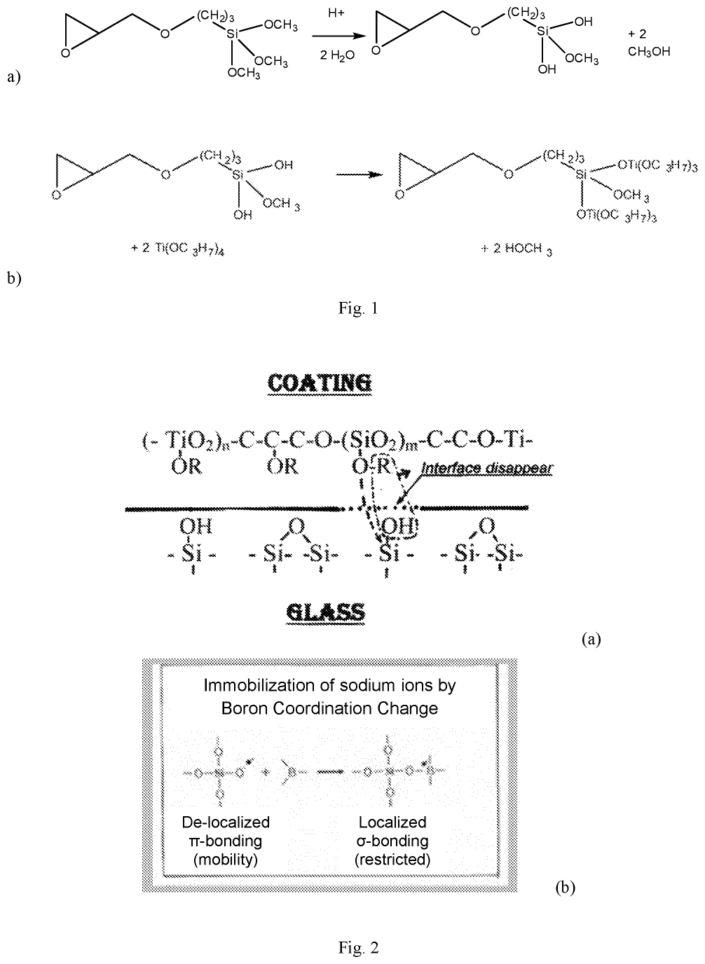

In the second step, composition b) is premixed and gradually added to the mixture obtain in step a) of the inventive method. The metal or metalloid oxide(s) and/or metal or metalloid alkoxide(s) must be introduced within a critical duration in order to prevent a significant self-polymerization of the partially hydrolyzed alkoxysilane. FIG. 1b shows an exemplary reaction between the compound obtained in FIG. 1a and Ti(OC₃H₇)₄. Under these circumstances for example, when the titanium alkoxide is introduced into the solution it can only react with the hydroxyl groups of glycidoxypropyltrimethoxysilane, thereby binding organic and inorganic components in a copolymer chain. This creates oxide bonding between organic and inorganic groups in a hybrid polymer solution (in a soluble form). In a different embodiment, composition b) is not premixed but mixed into composition a) by way of spraying the pure composition b) into the pure spray mist of composition a), or vice versa, as the components are applied to the glass of glass ceramic substrate.

At this stage, it is of importance that no free water must be present in the mixture at the end of the first part of the reaction otherwise the metal alkoxide will react with the free water and separately condensate or precipitate. Secondly, and as importantly, excessive time between the two reactions should be avoided as otherwise the hydrolyzed alkoxysilane will slowly self-polymerize detrimentally affecting homogeneity. The second part of the reaction has a minimum time requirement but unlike the first part of the reaction has no maximum time requirement. Most of the remaining alkoxy bonds from the copolymer can be done at any time with further water additions. Further addition of water leads to formation of a structure which is hard and abrasion resistant by removal of excessive organic groups and facilitating longer chain formation of oxide networks. There is, however, a limit of water addition, e.g. around 50% of total volume, the system can tolerate without causing cloudiness of the solution due to the solvent water insolubility.

After this bonding the product shown in FIG. 1b is totally hydrolysable to produce homogeneous inorganic-organic copolymers without fear of segregation or precipitation with further water additions. The resultant polymer is water and alcohol soluble thus can be diluted to any concentration for the deposition of desired film thickness on glass.

Step b) of the inventive method may be carried out for less than 60 minutes, such as less than 30 minutes, such as less than 20 minutes, less than 15 minutes, less than 10 minutes, less than 5 minutes, or even less than 1 minute. For example, the reaction time may be between 5 to 10 minutes, such as 6 to 10 minutes, or 8 to 10 minutes. As for step a), the reaction may be carried out at environmental conditions, such as at room temperature. In a preferred embodiment, step b) may be carried out under a water vapor free or an inert atmosphere, such as an oxygen free atmosphere or an inert atmosphere as described below.

In the third step, composition c) is added and the reaction mixture is stirred. This third step c) may be an optional step in the inventive preparation process.

Step c) may also be carried out be for less than 60 minutes, such as less than 30 minutes, such as less than 20 minutes, less than 15 minutes, less than 10 minutes, less than 5 minutes, or even less than 1 minute. For example, the reaction time may be between 5 to 10 minutes, such as 6 to 10 minutes, or 8 to 10 minutes. As for steps a) and b), the reaction may be carried out at environmental conditions, such as at room temperature. In a preferred embodiment, step a) may be carried out under a water vapor free atmosphere, an inert atmosphere, such as an oxygen free atmosphere or an inert atmosphere as described below.

In an alternative aspect, the present invention is directed to a method for preparing coatings for improving glass strength and fracture toughness of glass, the method comprises mixing
a) a composition comprising up to 25 wt. % of one or more metal or metalloid oxide(s) and/or one or more metal or metalloid alkoxide(s) in the presence of up to 20 wt. % water and 60-95 wt. % of an alcohol;
b) a composition comprising 5-95 wt. % of one or more alkoxysilane(s) of the general formula

RₓSi(OR¹)₄₋ₓ
wherein R is an organic radical, R¹ is independently selected from hydrogen and C₁₋₁₈ alkyl, or isomers or polyvalences thereof, and x is an integer from 0 to 3, 5-70 wt. % of an alcohol, up to 20 wt. % water and up to 0.5 wt. % of a catalyst; and
c) a composition comprising 10-50 wt. % one or more metal or metalloid oxide(s) and/or one or more metal or metalloid alkoxide(s), 10-90 wt. % water and up to 100 wt. % of an alcohol;
   wherein the weight percentage of a), b), c) and the mixture thereof, respectively, adds up to 100 wt. %.

In this aspect of the present invention generally the same reaction conditions as described above are used. The individual absolute weight of compositions a), b), and c) result in a total combined weight, with the relative weights of a)+b)+c) being 100%, the share of a), b), and c), respectively individually typically range for a) from 20 to 70 wt. %, for b) from 5 to 40 wt. %, and for c) from 0 to 50%. In one embodiment of the invention, the compositions are used in a ratio of 30-65 wt. % of composition a), 5-35 wt. % of composition b) and up to 50 wt. % of composition c). For example, the compositions are used in a ratio of 40-65 wt. % of composition a), 10-35 wt. % of composition b) and up to 50 wt. % of composition c). In another embodiment, the compositions are used in a ratio of 40-45 wt. % of composition a), 10-15 wt. % of composition b) and 10-50 wt. % of composition c). The sum of the amount compositions a), b) and c) adds up to 100 wt. %.

In one embodiment of this aspect of the present invention, composition a) is prepared and applied by a coating technique described below and subsequently cured. In a subsequent step, composition b) is prepared and composition c) is gradually added. The mixture of composition b) and c) is then applied to the glass coated with composition a) by a coating technique described below and subsequently cured. In one embodiment composition a) is applied and then the mixture of compositions b) and c) is applied and the a curing step is carried out.

In one embodiment of the aspects provided above, the composition a) or b) comprises 50-90 wt. % of one or more alkoxysilane(s). In one embodiment of the aspects provided above, the composition a) or b) comprises 65-75 wt. % of one or more alkoxysilane(s).

In one embodiment of the aspects provided above, the composition a), b) or c) independently comprises 1-30 wt. % of one or more metal or metalloid oxide(s) and/or one or more metal or metalloid alkoxide(s), if present. In one embodiment of the aspects provided above, the composition a), b) or c) independently comprises 5-25 wt. % of one or more metal or metalloid oxide(s) and/or one or more metal or metalloid alkoxide(s), if present.

In one embodiment of the aspects provided herein, the catalyst is present in an amount of 0.1-1 wt. %. In one embodiment of the aspects provided herein, the catalyst is present in an amount of 0.1-0.5 wt. %.

In one embodiment of the aspects provided herein, the amount of water present is >0 wt. % and within the ranges provided herein.

In one embodiment of the aspects provided above, composition a) is present from 20 to 70 wt. %. In one embodiment of the aspects provided above, composition a) is present from 30-65 wt. In one embodiment of the aspects provided above, composition a) is present from 40-65 wt. In one embodiment of the aspects provided above, composition a) is present from 40-66 wt. In one embodiment of the aspects provided above, composition a) is present from 40-50 wt.

In one embodiment of the aspects provided above, composition b) is present from 5 to 40 wt. %. In one embodiment of the aspects provided above, composition b) is present from 5-35 wt. In one embodiment of the aspects provided above, composition b) is present from 10-35 wt. In one embodiment of the aspects provided above, composition b) is present from 10-30 wt. In one embodiment of the aspects provided above, composition b) is present from 10-25 wt.

In one embodiment of the aspects provided above, composition c) is present from 0 to 50 wt. %. In one embodiment of the aspects provided above, composition c) is present from 5-50 wt. In one embodiment of the aspects provided above, composition c) is present from 10-50 wt. In one embodiment of the aspects provided above, composition c) is present from 15-50 wt. In one embodiment of the aspects provided above, composition c) is present from 20-50 wt.

Any combination of the above amounts is encompassed by the present invention.

The alkoxysilane to be used in the invention provided herein may generally be any alkoxysilane that can react with one or more metal or metalloid oxide(s) and/or metal or metalloid alkoxide(s), i.e. that has reactive groups or can provide reactive groups upon reaction with water. In one embodiment, the one or more alkoxysilane(s) may be selected from the general formula RₓSi(OR¹)₄₋ₓ.

R may be selected from an organic radical, such as, for example but not limited to, C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof.

A C₁₋₁₈ alkyl group is a saturated straight chain or branched non-cyclic hydrocarbon having, for example, from 1 to 18 carbon atoms, from 1 to 15 carbon atoms, from 1 to 12 carbon atoms, from 1 to 10 carbon atoms, from 1 to 6 carbon atoms, from 1 to 4 carbon atoms, from 1 to 3 carbon atoms, 2 carbon atoms or only 1 carbon atom. The alkyl group may be selected from the group consisting of methyl, ethyl, n-propyl, i-propyl, n-butyl, i-butyl, s-butyl, t-butyl, n-pentyl, t-pentyl, neo-pentyl, i-pentyl, s-pentyl, hexyl, heptyl, octyl, nonyl, decyl, undecyl, dodecyl, tridecyl, tetradecyl, pentadecyl, hexadecyl, heptadecyl, and octadecyl, or isomers or polyvalences thereof, but is not limited to. The alkyl group may be optionally substituted with further alkyl groups, hydrogen, halogen, and/or —CN, or the like.

A C₁₋₁₈ heteroalkyl group is a C₁₋₁₈ alkyl group as defined above, wherein one or more carbon atoms are substituted by heteroatoms independently selected from the group consisting of oxygen, sulfur and/or silicon.

A C₁₋₁₈ alkoxy group is an alkyl group, as defined above, singularly bonded to oxygen. Representative alkoxy groups include methoxy, ethoxy, n-propoxy, isopropoxy and n-butoxy, but are not limited to.

A C₂₋₁₈ alkene group is an unsaturated hydrocarbon having 2 to 18 carbon atoms and having one or more carbon-carbon double bonds, such as for example, but not limited to, —CH═CH₂, —CH═CH—CH₃, —CH₂—CH—CH₂, —CH—CH—CH₂—CH₃, —CH═CH—CH═CH₂ and the like. The alkene group may be optionally substituted with further alkyl groups, hydrogen, halogen, and/or —CN and the like.

R² in the above formulae may be hydrogen, C₁₋₁₈ alkyl, (C₂H₄O)—(R³)ₘ— or C₂₋₁₈ alkene, or isomers or polyvalences thereof. In one embodiment R² may be (C₂H₄O) CH₂—O—(CH₂)₃—.

R³ may be independently selected from C₁₋₁₈ alkyl, or isomers or polyvalences thereof.

X may be an integer from 0 to 3, for example x may be 1, 2 or 3. n may be an integer from 0 to 10, such as 0, 1, 2, 3, 4, 5, 6, 7, 8, 9 or 10. m may be an integer from 0 to 10, such as 0, 1, 2, 3, 4, 5, 6, 7, 8, 9 or 10.

In one preferred embodiment low chain polymer molecules are used to allow for better penetration into the microcracks. In a further embodiment, low chain polymer coating material may be first introduced to enable best penetration towards the tip of the microcrack, followed by a second coating on top of the first coating that fills any remaining gaps even. Applying this technique creates the maximum possible coverage of reacting “partners”, i.e. coated chemical compounds with the terminating Si—OH bond. In this regard “low chain polymer molecules” may have an alkyl, heteroalkyl, alkoxy or alkene group having less than 18 carbon atoms, such as less than 15 carbon atoms, less than 10 carbon atoms, less than 8 carbon atoms, less than 5 carbon atoms, or even less.

In one embodiment the one or more alkoxysilane(s) is selected from glycidoxypropyltrimethoxysilanes, such as (1) β-glycidoxypropyltrimethoxysilane or (2) γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane. In one embodiment the alkoxysilane is a glycidoxypropyltrimethoxysilane. In a preferred embodiment the alkoxysilane is γ-glycidoxypropyltrimethoxysilane. These chemicals are many and varied and can be purchased by any number of chemical supply houses.

The one or more metal or metalloid oxide(s) and/or one or more metal or metalloid alkoxide(s) may generally be selected from any metal compound that can react with the one or more alkoxysilane(s). For example, the metal component of these compounds may be selected from boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, or polonium, but is not limited thereto. In one embodiment the one or more metal or metalloid oxide(s) and/or the one or more metal or metalloid alkoxide(s) are selected from oxides and/or alkoxides of aluminum, silicon and/or titanium. In one embodiment the metal is titanium and/or silicon. The alkyl part of the alkoxy group may be selected from methyl, ethyl, n-propyl, i-propyl, n-butyl, i-butyl, s-butyl, t-butyl, n-pentyl, t-pentyl, neo-pentyl, i-pentyl, s-pentyl, hexyl, heptyl, octyl, nonyl, decyl, undecyl, dodecyl, tridecyl, tetradecyl, pentadecyl, hexadecyl, heptadecyl, and octadecyl, or isomers or polyvalences thereof, but is not limited to. In one further embodiment the metal alkoxide may be, but is not limited to, B(OCH₃)₃, B(OC₂H₅)₃, B(OC₃H₇)₃, Ti(OCH₃)₄, Ti(OC₂H₅)₄, Ti(OC₃H₇)₄, Ti(OC₄H₉)₄, Zr(OC₂H₅)₄, Zr(OC₃H₇)₄, Zr(OCH₉)₄, Al(OC₂H₅)₃, Al(OC₃H₇)₃, Al(OCH₉)₃, Si(OCH₃)₄, Si(OC₂H₅)₄, Si(OC₃H₇)₄, CH₃Si(CH₃)₃, or (CH₃)₂Si(OCH₃)Cl, or in lieu of the metals outlined above any other metals. The alkyl group may be optionally substituted with halogen, such as e.g. fluorine, chlorine, bromine, or iodine. In one embodiment, the alkoxysilane is reacted with at least two different metal compounds selected from any of the above defined metal and/or metalloid oxide(s) and/or metal and/or metalloid alkoxide(s). In one embodiment one of the at least two different metal compounds is a silicon compound.

In one embodiment the above-mentioned one or more metal or metalloid oxide(s) and/or the one or more metal or metalloid alkoxide(s) is not an oxide and/or alkoxide of cer. In one embodiment the above-mentioned one or more metal or metalloid oxide(s) and/or the one or more metal or metalloid alkoxide(s) is not an oxide and/or alkoxide of tin. In one embodiment the above-mentioned one or more metal or metalloid oxide(s) and/or the one or more metal or metalloid alkoxide(s) is not an oxide and/or alkoxide of aluminum.

In one embodiment the alkoxysilane is β-glycidoxypropyltrimethoxysilane, γ-glycidoxypropyltrimethoxysilane and the one or more metal or metalloid alkoxide(s) is selected from titanium alkoxide(s) and/or silicon alkoxide(s). For example, the alkoxysilane may be γ-glycidoxypropyltrimethoxysilane and the one or more metal alkoxide(s) may be, but is not limited to be selected from, but is not limited to, B(OCH₃)₃. Ti(OC₂H₅)₄, Ti(OC₃H₇)₄, Si(OCH₃)₄, Si(OC₂H₅)₄, CH₃Si(CH₃)₃, or (CH₃)₂Si(OCH₃)Cl, or any other metal mentioned outlined above.

In one embodiment the alkoxysilane is γ-glycidoxypropyltrimethoxysilane and the one or more metal alkoxide(s) are B(OCH₃)₃. Ti(OC₂H₅)₄, Ti(OC₃H₇)₄, Si(OCH₃)₄, Si(OC₂H₅)₄, CH₃Si(CH₃)₃, or (CH₃)₂Si(OCH₃)Cl.

In one further embodiment, the coating to be used is the product of hydrolytic polycondensation of γ-glycidoxypropyltrimethoxysilane with titanium alkoxides.

The coating provided can be made hydrophobic when the respective metal compounds contain some alkyl bonds instead of only possessing alkoxy bonds. Alkyl bonds in these compounds are inert, remaining as terminally stable terminal groups with their hydrophobic properties. Hydrophobicity can also be induced to the coating by inclusion of soluble or dispersible fluorine compounds into the precursor coating solution. Fluorine compounds generally used in this field may be used in the inventive coating, such as for example, fluorinated alkyl or alkoxy groups, but not limited to.

Exemplary coatings used according to the invention may be, but are not limited to,

| | | |
|---|---|---|
| γ-glycidoxypropyltrimethoxysilane | 100 | g |
| Ethanol | 25 | g |
| Si(OC₂H₅)4 | 0 to 25 | g |
| Water | 10 to 12 | g |
| HNO₃ | 0 to 0.3 | g |
| Ti(OC₂H₅)₄ | 25 to 40 | g |
| Water (solvent) | 20 to 150 | g |
| Ethanol (solvent) | 0 to 100 | g |

| | | |
|---|---|---|
| γ-glycidoxypropyltrimethoxysilane) | 8 | g |
| Ethanol | 25 | g |
| H₂O | 8 | g |
| HNO₃ | 0.5 | g |
| Ti(OC₂H₅)₄ | 40 | g |
| H₂O (solvent) | 150 | g |

| γ-glycidoxypropyltrimethoxysilane) | 250 | g | 250 | g | 250 | g |
|---|---|---|---|---|---|---|
| Ethanol | 60 | g | 60 | g | 60 | g |
| Si(OC₂H₅)₄ | — | | — | | 50 | g |
| Water | 25 | g | 25 | g | 30 | g |
| HNO₃ | 0.3 | g | 0.3 | g | 0.3 | g |
| Ti(OC₂H₅)₄ | 100 | g | 100 | g | 100 | g |
| Water (solvent) | 75 | g | 250 | g | 80 | g |
| Ethanol (solvent) | 250 | g | 50 | g | 250 | g |

| | | | | |
|---|---|---|---|---|
| γ-glycidoxypropyltrimethoxysilane | 300 | g | 300 | g |
| Ethanol | 75 | g | 75 | g |
| Si(OC₂H₅)₄ | 75 | g | 75 | g |
| Water | 36 | g | 36 | g |
| HNO₃ | 0.5 | g | | |

| | | | |
|---|---|---|---|
| NH₃OH | 0 | 0.5 | g |

| | | | | |
|---|---|---|---|---|
| Ti(OC₃H₇)₄ | 135 | g | 135 | g |

| | | | |
|---|---|---|---|
| HNO₃ | 0 | 0.5 | g |

| | | | | |
|---|---|---|---|---|
| Water (solvent) | 75 | g | 450 | g |
| Ethanol (solvent) | 300 | g | | |

The coating is soluble in a suitable solvent depending on whether the coating has hydrophilic or hydrophobic properties. In one embodiment, the solvent is an organic solvent. In one embodiment the solvent is a hydrophilic solvent. Non limiting examples of a solvent are alcohol or water, optionally augmented by surfactants. In one embodiment the solvent may be ethanol, propanol, water or mixtures thereof, optionally including surfactants. The amount of 10 solvent is used to adapt the viscosity and/or concentration of the coating and/or the surface tension. In controlling the viscosity and/or concentration of the solution and/or the surface tension, the penetration into the apex of surface flaws may be controlled.

The viscosity of the coating may also be controlled by specifically selecting (starting) components having a desired viscosity. In one embodiment penetration into the cracks of the glass surface as described above may be increased by decreasing the viscosity of the coating or coating solution.

The coating provided herein provides a structure of a soluble organic-inorganic copolymer that deposits on glass surface as a transparent, non-brittle, yet virtually as hard and abrasion resistant film as the substrate glass surface.

In addition to the above, a positive impact with regard to the non-formation of cracks in the glass may be expected from preventing water vapor (typically from humidity in ambient or compressed air) be present in the atmosphere anywhere from the process steps melting, gob formation (or other exposure of molten glass to the atmosphere), hot forming (such as e.g. pressing, blowing, floating, updraw, downdraw, overflow fusion, tube drawing, rod drawing), through finally applying the coating. Preventing water molecules from being present at the glass surface may limit the micro-crack formation. It is believed, without wishing to be bound by theory, that the presence of water vapor may support the crack propagation as the hydroxyl groups that are needed to fill the full valence band of the Silicon atom (4-valent), that, at the surface, needs an (OH) group to complete the 4th valence. Without water vapor present, that valence cannot be filled, and according to the theory, the crack requires significant larger forces to propagate. Even small amounts of water present e.g. in the atmosphere is believed to trigger the crack propagation, and its absence, or at least very low concentration may largely limit crack propagation.

Crack propagation by the coating is prevented inter alia in that the coating penetrates the crack all the way to the tip of the crack to create a maximum effect.

In one embodiment the surface of the damaged silica containing material, including or excluding its edges, is pre-treated. Pre-treatment can improve the adhesion of the coating and/or reduce the depth of micro-cracks and/or the radius of the micro-cracks in the glass surface. Pre-treatment can be carried out with any suitable (chemical) material. For example, such pre-treatment can be carried out with hydrofluoric acid, with mechanical edge grinding, with flame polishing, with laser treatment and/or with any other edge treatment technology, or by any other suitable methodology. By pre-treating the silica containing material, the coating can more effectively and more completely penetrate the surface of the micro-cracks in the silica containing material, and in addition, can reduce any mechanical defects particularly imposed on the edges of the silica containing material.

In one embodiment, the silica containing (including but not limited to compound) materials in the form of porous materials or powders, such as lose or compacted (compressed, prepregged, sintered, etc.) are soaked with the coating partly or entirely throughout the pores or within the powder cluster. The soaking of the material or powder may be carried out for more than 1 second, more than 10 seconds, more than 1 minute, more than 1 hour, more than 1 day, or even more than 1 week or even longer in order to enable full soaking of the voids between pores, between grains, or between substrate parts. The soaked material may then be formed and cured, heated, further pressed, or sintered as described herein to prepare the final product. The powder or porous material may be formed to a prepreg material prior to the soaking or soakage.

In one embodiment the silica containing material, preferably glass, is heat treated to a suitable temperature below or around or even above the transformation temperature T_{g} prior to applying the coating to reduce either the depth or the radius or both of the micro-cracks in the glass surface. Suitable temperatures are at least 300 K below the transformation temperature T_{g}. In other embodiments suitable temperatures below the transformation temperature T_{g} are at least 100 K, 125 K, 150 K or even more. In one embodiment, a shock cooling can be applied. Heat treatment with or without shock cooling may enable the coating to more effectively and more completely penetrate the surface of the micro-cracks in the glass substrate. In addition, this method may enable defects (e.g. grains) within the glass substrates' body to homogenize or even dissolve.

In one embodiment any mechanical defects resulting from cutting or similar procedures resulting in uneven edges of the silica containing materials are pretreated prior to applying the coating either with chemical etching, flame polishing, defined edge grinding, or any other edge smoothening methodology, or with any combination thereof.

Upon using the coating provided herein mechanical glass strength is improved compared to uncoated glass products. The increase is controllable depending on the coating used and may provide a minimum increase in mechanical strength by 50%. In one embodiment the strength is increased by more than 100%, by more than 150%, by more than 250%, by more than 300%, by more than 500%, by more than 1000%, by more than 1500%, by more than 2000%, by more than 5000%, or by even more than 10000%. The glass strength increases more than 0.5-fold, more than 1-fold, more than 1.5-fold, more than 2.5-fold, more than 3-fold, more then 5-fold, more than 10-fold, more than 15-fold, more than 20-fold, more than 50-fold or even more than 100-fold versus the genuine, untreated glass substrate. The improvement relates to the baseline mechanical strength of untreated glass after melting, forming and cooling. The limitation of increases in mechanical strength may only be restricted by safety related concerns. As the mechanical strength is increased, the resulting available energy released at the break point will result in more violent energy release and showering of smaller glass segment or particles. The improvement in mechanical strength can be easily controlled with the present invention within an accuracy of up to 100%. The change in mechanical strength can be measured by any method known to the skilled person, such as 3-point or 4-point glass probe, ring-on-ring probe, hydrostatic pressure with any fluid building pressure until device breaks, force increase per unit time (comparison of 2 different populations of glass), or other methods. The effectiveness of the chemical bonding can be proven by quantitative Auger electron spectroscope, electron probe micro-analyzer (EPMA) techniques, or any other method known to the skilled person.

In one embodiment the improvement in glass strength (and toughness) is between 50 to 5000%, such as between 50 to 4500%, between 50 to 4000%, between 50 to 3500%, between 50 to 3000% or between 50 to 2500%. In one embodiment the improvement in glass strength is above 5000% or even above 10000%. The improvement in strength of silica containing materials can be achieved either with newly manufactured silica containing material or with damaged silica containing material s-new or used-upon repairing the same using the inventive coating composition. In addition, the ductility may be increased, and the brittleness may be reduced.

The coated glass has a glass strength (and toughness) of at least 150 MPa. For example, the coated glass has a strength of at least 150 MPa, 200 MPa, at least 250 MPa, at least 500 MPa or more. In other embodiments, the glass strength may be at least 120 MPa, at least 100 MPa or at least 75 MPa. The strength parameters do also apply to other silica containing materials described herein.

The increase in glass strength along with the increase in ductility may enable the coated glass to withstand high temperature differentials e.g., cooling from ambient or elevated temperatures to cryogenic temperatures or vice versa from cryogenic temperatures to ambient or elevated temperatures. For example, the coated glass may easily withstand temperature differences of more than 50 K, more than 100 K, more than 150 K, more than 200 K, or even more than 250 K when freezing glass from ambient to very low temperatures or when thawing glass that has been kept at temperatures below 0° C. within a very short time frame. In an exemplary embodiment, vials stored at −78° C. (195 K) or at −196° C. (77 K) or at −269° C. (4 K) and being warmed to room temperature within a very short time frame (such as e.g. vials for pharmaceutical vaccines) do not suffer from breakage as both, the glass strength and the ductility of the glass surface will have significantly increased by the application of subject invention.

The index of refraction of the coating can be adjusted to a desired value by adjusting the relative concentration of the metal component in the copolymer.

The glass coated by the coating provided herein may have no worse than 4% haze after 300 cycles in Bayer abrasion testing defined by ASTM-F735.

The increase in glass strength along with the increase in ductility may enable the coated glass to withstand or at least allow a higher impact force deriving from solid objects impacting on glass at more or less high speeds at different angles. In an exemplary embodiment, photovoltaic glass panels, solar thermal glass panels or tubes, or window glass would withstand larger hail balls or stones at higher speed impacting on these panels without causing fracture or other damage. In a further exemplary embodiment, coated glass would withstand higher impacts induced by violent action such as bullets or battering rams or other impacting devices impacting on the coated glass.

The increase in glass strength along with the increase in ductility may enable container glass—including but not limited to glass bottles, glass jars, drinking glasses, or any other glass with a closed or open hollow volume—to withstand significantly higher pressure from inside the container or to withstand significantly higher forces from any impact. In an exemplary embodiment, bottles (containers) filled with liquids that contain carbon dioxide can be prone to high or even excessive pressures e.g. from rising ambient temperatures, and therefore, either the glass bottle (container) can be manufactured with a lower wall thickness to same pressure as the non-treated glass or it can withstand significantly higher pressures. By the same token as in above section [0068], without limiting the effect to a particular glass, a container such as for example a bottle, a jar, or a drinking glass could withstand falling on the floor without being damaged at all or at least only causing little damage compared to a wine glass that is not coated with subject coating that usually breaks on impact. Also, reusable bottles (containers) can be coated with the inventive coating and thus can be used much longer in the deposit or reuse system before it is necessary to melt the bottles (containers) again and form new bottles (containers). This prolongation in the deposit or reuse system can save energy and raw materials.

The presence of additional silicon in the coating may also facilitate a better bonding between the coating and glass and may have the additional advantage of lowering the index of refraction for a better match to the substrate glass as well as better adherence of the coating on the glass surface, due to the fact that silicon alkoxides retain some of the alkoxy bonds, even under excess water, and these bonds react with the hydroxyl bonds of the glass surface during the heat treatment. FIG. 2 for example is a schematic representation of a chemical bonding of the coating on a glass surface showing the covalent bonding the coating to the glass (a) and shows the immobilization of sodium ions by boron coordination change.

According to the invention one or more coatings may be applied to the glass substrate. In case more than one coating is applied, the additional coatings may have different properties and may provide different or enhanced functionality to the glass substrate. For example, different coatings may provide different magnitudes of strength. In one embodiment, one coating layer may provide additional oxygen sites or other bridging 2-valent species, such as sulfur, selenium, tellurium, polonium, copper or ytterbium, but not limited thereto, to allow more covalent bonds for a second coating. The second or more coating may provide additional protection against, for example, staining, weathering and/or imposing harm by energy release at the breakage force or may provide additional abrasion-resistance and/or chemical resistance. With the second or further coating the chemical bonds can be selectively created to ensure best uniformity of the bonds creating coatings on an Angstrom or higher level from the tip of the crack, layer-by-layer to the surface, to further control the strength of the glass. In one embodiment, the abrasion resistance may be improved with the second or further coating. The second or more coating may thus provide (1) protection against staining, weathering, and/or harm deriving from energy release at the breakage force point, (2) improvement of abrasion resistance, (3) improving birefringence, (4) modification of the index of refraction, (5) increase hardness, (6) protection of photovoltaic or semiconductor devices from potential induced degradation, (7) control of the increase in mechanical strength to its design strength, within an accuracy of −50%/+100%, (8) fungicidal, antibacterial, and/or antiviral properties, and/or (9) repelling water by hydrophobicity and/or oil, grease etc. by oleophobicity.

Another important aspect relates to the application of the coating to the glass surface. In order for the coating to reach the tip of the crack, it may be conducive that no restraining force, most importantly from oxygen, nitrogen or water molecules or from argon atoms (or other species contained in the atmosphere) prevents this. Therefore, a controlled atmosphere by means of industrial or specialty gases such as e.g. helium, hydrogen, neon, dry air, nitrogen, argon, oxygen, ozone, carbon dioxide or the like or a vacuum is advantageous to facilitate penetration of the coating to the tip of the crack. In one embodiment, the controlled atmosphere is characterized by using helium, hydrogen, neon, oxygen and/or ozone. In one embodiment, the controlled atmosphere is characterized by being oxygen-free. The vacuum may be of an absolute pressure of up to 950 hPa, preferably below 500 hPa, more preferably below 100 hPa, even more preferably below 10 hPa or even less. In one embodiment the vacuum may be below 1 hPa or, if economically justifiable even more preferably below 0.1 Pa, or even less than 10-6 Pa, or even less than 10-9 Pa. The controlled atmosphere may be applied in the application space and/or the space from the glass outlet through the hot forming device.

Additionally or alternatively, heating the chemical solution to just below the boiling point of the solvents and/or having the glass substrate heated to a sufficiently high temperature will open the cracks as well as lowering the viscosity and increasing the penetration of the coating to allow better penetration, and therefore, healing of the surface flaws. Additionally, or alternatively to the above, heating the chemical solution to above the boiling point transforms the same to the gaseous stage or further energizing the chemical solution even to the plasma stage and/or having the glass substrate heated to a sufficiently high temperature will open the cracks as well as further lowering the viscosity and increasing the penetration of the coating to allow better penetration, and therefore, healing of the surface flaws.

The coating can be applied by various methods known to the skilled person in this field. For example, the coating may be applied either from liquid (including gel), from gaseous, or from plasma states. There is a possibility that the coating can be applied from solid states, most likely in the form of nano-powders. The coating may be applied with any suitable application technique used in this technical field. In one embodiment, the coating may be applied, but is not limited to, by dip coating, spray coating, roller coating, vapor deposition (such as CVD, PECVD), nebulizing, plasma outside deposition, chemical vapor deposition and/or plasma induced vapor deposition (such as PICVD). The coating may also be added to a suitable solvent, such as H₂O, which is used as a starting material for certain materials, such as concrete or cement or any other material which makes use of a solvent or solvent mixtures. This allows a thorough and uniform distribution of the coating within the material.

For example, if dip coating is applied, pull-out velocity range between 20 mm/minute and 15,000 mm/minute (250 mm/s), such as between 50 mm/minute and 10,000 mm/minute or 100 mm/minute and 1,000 mm/minute. A faster pull-out rate typically creates a thicker coating film, a too slow pull-out rate may result in polymerization of the coating on the glass substrate surface while pulling out. Therefore, the ideal pull-out rate depends on various factors such as viscosity, reaction time of the chemical compounds etc. Typical thickness of dip coating process is between 1 and 10 microns, such as between 3 and 7 micros. The thickness can also be (substantially) lower than 1 micron, and an as low as possible coating thickness is desired.

In one embodiment, the compositions a) and b) as described above may be applied subsequently by any of the above methods. In one embodiment, the compositions a) and b) may be applied by spray coating or nebulizing using either one or more than one different spray nozzles. In this embodiment, the coatings may be applied simultaneously or in subsequent coating steps. If one spray nozzle is applied, the chemical compound would need to be premixed prior to the nozzle inlet. If more than one spray nozzle is applied, the chemical compounds would either be premixed prior to the nozzle inlet or the individual compositions a), b), and/or c) would be injected through separate nozzles such that the separate sprays merge prior to the glass substrate surface or on the glass substrate surface. The application of subsequent coating steps through separate nozzles for each composition a), b), and/or c) may as well be applied. In the event of nozzles spraying compositions separately, besides individual compositions a), b), or c) through any nozzle, any premixed combination of (i) a) and b), (ii) a) and c), or (iii) b) and c) may be fed into the nozzle inlet. Any nozzle may have individual geometries responding to the optimum spray atomization. In one embodiment, atomization may be realized with pressure without using any carrier species. In another embodiment, atomization may be realized with compressed air, or with a pressurized gas or gas mixture, for example an inert gas, for example nitrogen, but not limited to. Other techniques of atomization are possible, such as e.g. mechanical or other trimwork or fixtures, electromechanical devices, or plasma.

The application of the coating may be supported by the use of a catalyst, such as e.g. but not limited to water, preferably de-ionized water, more preferably distilled water, even more preferably multiple distilled water, e.g. so called “bi-distilled” water, for example to increase the reaction rate of the coating with the hydroxyl groups in the crack on the glass substrate. Such catalyst may be the presence of a particular specie or may be particular process parameters, such as for example temperature, pressure, plasma, or the like.

It is also encompassed herein that unused or residual coating, that is not required for the chemical reaction to create the covalent bonding needed for the reaction to heal some or all of the micro-fissures, is removed (i.e. recovered) after the coating has been applied, for example by dipping the coated glass into or rinsing the coated glass with a suitable solvent such as water and/or alcohol, such that enough of the coating would remain in the previous cracks to allow the bonding and healing to take effectively place. The suitable solvent may be, but is not limited to, water, ethanol, iso-propanol, or mixtures thereof. In a preferred embodiment the solvent used is ethanol. Thus, no coating is left other than the quantity that's needed for the reaction healing the micro-fissures for resulting in the same increase in strength while at the same time saving coating and also allowing the pristine glass showing essentially the same visual property as uncoated.

After application the coating is dried to remove the solvent and excess water and then heated to promote the continued condensation or precipitation polymerization of the coating and curing to a dense glassy film. Heat treatment is carried out irrespective of the coating method described above. Heat treatment may be conducted at a suitable temperature for a suitable amount of time. For example, the coated glass may be heat treated at 100 to 500° C., such as 100 to 400° C., 100 to 300° C. or 100 to 200° C. for 30 minutes, 60 minutes, 2 h or even longer than 2 h, but is not limited to. Process temperatures of greater than 150° C., and even more than 200° C. may result in shorter treatment and/or curing times, which is generally preferred. The drying step may also be supported by using vacuum of an absolute pressure of 950 hPa, preferably below 500 hPa, more preferably below 100 hPa, even more preferably below 10 hPa or even less.

After the application of the coating, the coating is cured. In one embodiment, the curing of the applied coating takes place at temperatures above 30° C., such as above 50° C., above 80° C., above 100° C., above 120° C., above 130° C., above 150° C., above 200° C., or even above 300° C. The curing temperature is applied for a time period sufficient to accomplish the curing. For example, curing may be carried out in a period of time that lasts milliseconds, such as at least 100 ms, 200 ms, or more, seconds, such as at least 10 s, 30 s, 45 s, or more, or even minutes, such as at least 1 min, 2 min, 3 min, 5 min, 10 min, 20 min, 30 min or even longer.

In another embodiment the curing is triggered by exposing the coated silica containing material, preferably, glass, to particular waves of suitable frequencies and/or wavelength. Non-limiting examples of a suitable wavelength range/radiation are e.g. ultrasound such as subsonic, sonic or supersonic range, visible range, ultraviolet range, extreme ultraviolet range, infrared range, microwave range, or any other distinct range responding to the particular correlated wavelengths that trigger the molecules to react (e.g. individual eigenfrequency of the molecular reactant group).

In another embodiment the coated silica containing material is exposed to tempering prior to or after coating.

In one embodiment of the method of the present invention, composition a) and composition b) or composition a) and the mixture of composition b) and composition c) may be applied sequentially to the glass surface and also cured sequentially.

In some hot forming processes, it might be possible to create a controlled atmosphere or a vacuum of an absolute pressure of up to 950 hPa or less with no or very little water vapor content, e.g. conditioned air with a dew point below −20° C. (253 K), more preferably at or below −50° C. (223 K), more preferably at or below −78.5° C. (194,7 K), if economically justifiable even more preferably at or below-195,8° C. (77,35 K), more preferably at or below −246° C. (27 K), more preferably at −269° C. (4 K) from the outlet of the molten glass to anywhere throughout the forming device or even through an annealing furnace, thus as much as possible preventing water reacting with the glass surface, and therefore, improving the result of the chemicals reacting with the glass surface instead. In addition, the lack or the significant reduction of the presence of water vapor may prevent the crack propagation during the crack formation process, and therefore, less coating material may be required as the depth of the crack and its resulting volume may be smaller and the “penetration resistance” of the coating into the void(s) resulting from the crack may be largely reduced.

With the present invention, any of the process steps from batch storing, batch mixing, batch charging, if applicable batch preheating, melting, refining, gob formation, hot forming etc. until the application of the coating or even the entire or parts of the entire process from batch storing through application of the coating can optionally take place in a controlled atmosphere (as described above) with very low water vapor pressure (water vapor partial pressure).

The use of the coating will benefit all glass applications and products. For example, but not limited to, the coating may be applied to containers for e.g. beverages, spirits, food, pharmaceuticals; flat glass (e.g. automotive, architectural, solar photovoltaic, solar thermal), electronic devices (e.g. computer displays, laptops displays, smartphones, wafer level packaging); mirrors or mirror substrates, aerospace applications, astronomy applications, ophthalmology devices, optical devices, optical or other communication fibers, textile reinforcement fibers, insulation fibers, tube and/or rod glass (e.g. for pharmaceutical packaging, solar thermal, solar photovoltaic, lighting tubes), mask blanks (for microlithography), glass, ceramic, glass-ceramic, or composite membranes (e.g. for batteries, fuel cells), pressed glass for e.g. high precision reflectors, LED or OLED applications, glass powders, as protection against leaching or for waste vitrification glasses (e.g. ash vitrification, nuclear waste vitrification).

The invention is not limited to a specific glass type but may be applied to any glass and for any purpose. Suitable glass types may include, but are not limited to, soda-lime, boro-silicate, alumino-silicates, opal glass, sapphire, calcium fluoride, chalcogenite glasses, silica (pure or doped), glass ceramics, ceramics, pure or impure quartz, glass or quartz crystals, composite materials consisting of any type of glass or ceramic or glass ceramic and at least one other material, or the like. For example, the coating may be applied to all glasses that are molten at high temperatures of min. 450° C., at temperatures of more than 1100° C., or temperatures of more than 1400° C. Generally, there is no limitation concerning the upper temperature, i.e. the coating may be applied to any molten or formed glass upon reaching a temperature suitable to apply the coating, i.e. without the coating to decompose. The coating may thus be applied, for example and as far as no decomposition of the coating material takes place, to all glasses manufactured or formed at or around the transition temperature (T_{g})+/−300° C., or all glass produced by applying the sol-gel process at temperatures below 1200° C., below 1000° C., below 850° C., below 600° C., below 450° C., below 300° C., or even below 150° C., such coating being applied upon reaching a suitable temperature. In one embodiment, the coating may be applied at temperatures below 450° C.

In one embodiment, the inventive coating is not applied to polymeric substrates. In one embodiment, the inventive coating is not applied to polycarbonates. In one embodiment, the inventive coating is not applied to acrylates.

The invention is also suitable for all possible preparation processes, such as, but not limited to, any hot forming technology, in particular but not limited to press-blow (e.g. in individual section machines, NNPB(narrow neck pressure blow)), blow-blow process, float glass, rolled flat glass, tube forming (e.g. tube drawing by Danner process, Vello process etc.), pressing, updraw, downdraw, overflow fusion, pressing, mouth-blowing, casting, carrousel type machines, tube-to-container conversion; any temperature cooling or heating device to control the glass temperature and glass temperature distribution.

In one embodiment, prior to the application of the coating, the glass in a molten state is stretched immediately following a hot-forming process for creating thinner glass and/or for reducing glass defects.

In a further aspect the present invention is directed to a glass or silica containing product having a coating as described herein.

The coating on the glass product may have a thickness that is suitable for the respective purpose. For example, the coating may have a thickness of less than 10 microns. In one embodiment the coating may have a thickness of less than 5 microns, such as less than 3 microns or less than 2 microns, or even less than 1 micron. Even thinner coatings may be applied. The coating may be controlled in several ways, such as the viscosity and/or concentration of the coating solution and/or surface tension, the duration of applying the coating to the glass, the temperature, the control of atmosphere, the ambient pressure or vacuum of an absolute pressure as defined above, and the like. Generally, a lower viscosity is conducive to the effectiveness of the coating liquid to penetrate the micro-cracks resulting in more reacting partners and thus, creating more covalent bonds.

It is generally favorable to provide the coating as thin as possible.

In a further aspect the present invention is directed to a coating prepared by a method provided herein,

In a still further aspect the present invention is directed to a coating comprising a mixture of
a) a composition comprising 50-85 wt. % of one or more alkoxysilane(s) of the general formula

RₓSi(OR¹)₄₋ₓ
with up to 35 wt. % one or more metal or metalloid oxide(s) and/or one or more metal or metalloid alkoxide(s) in the presence of up to 10 wt. % water and up to 30 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
   wherein the weight percentage of a), b), c) and the mixture thereof, respectively, adds up to 100 wt. %.

In this aspect of the invention the information and specific embodiments as provided above also apply.

In a still further aspect the present invention is directed to a method for improving (mechanical) glass strength comprising applying one or more coating(s) as provided herein to the glass. The one or more coating(s) is/are applied as described above. The method may further comprise the step of preparing the one or more coating(s) as provided herein.

All the above embodiments may be combined in any possible way. The embodiments specifically directed to glass do also apply to the other silica containing materials described herein.

### EXAMPLES

To describe the present invention in more detail and assist in understanding the present description, the following non-limited examples are provided to fully illustrate the scope of the description and are not to be construed as specifically limiting the scope thereof.

### Example I

A transparent, hard, and non-brittle coating solution is prepared as follows. 100 grams of glycidoxypropyltrimethoxysilane,

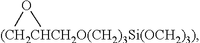

is mixed with 100 grams of ethyl alcohol, C₂H₅OH. To this mixture, 8 grams of water and 0.3 grams of nitric acid, HNO₃, is added and stirred for 10 minutes. This procedure hydrolyzes the methoxy groups of the compound converting them to hydroxyls. After this, 40 grams of titanium ethoxide, Ti(OC₂H₅)₄, is also added and stirred for another 10 minutes to react with the hydroxyl bonds thus, chemically bonding the titanium compounds to glycidoxypropylsilane's molecular structure through oxygen. Once titanium and organic component chemically bonded by this procedure, additional water can be added without fear of causing segregated condensation or precipitation. This water causes further polymerization of the system to long chains and leads to hardness of the coating by stripping the excessive organics from the structure.

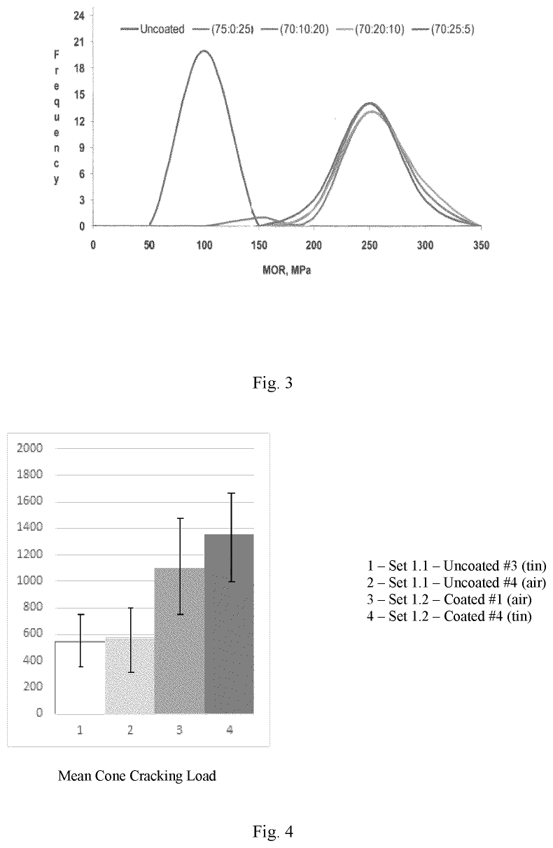

A number of 10 cm×10 cm, 2 mm thick float glass samples are coated by dipping into this solution and heat treated for 30 minutes at 130° C. Their abrasion resistance is tested by ASTM F-735 Bayer abrasion testing method for 300 cycles and found to be around 1.0 which is virtually similar to the abrasion resistance of uncoated glass surface. The strengths of these samples were also measured by the customary ring over ring method and “cone cracking load” method at Penn State University. The results are shown in FIG. 3. The uncoated glass showed the typical bell shaped strength distribution between 50 to 150 MPa with an average mean value of around approximately 100 MPa; whereas the test of the coated samples gave a strength distribution in the range of approximately 200 to 350 MPa, the mean strength was around approximately 250 MPa, a strength increase of 2.5 fold. FIG. 4 is a comparison of the average and the range of the mean cone cracking load of the glass samples. It can be seen that the “tin side” of the glass (i.e. the bottom of the floating glass that is in contact with the tin bath on which the glass floats) has a significantly lower crack resistance than the “air side” (i.e. the top of the floating glass) due to microscopic defects imposed through the above and other phenomena. More importantly are defects in the surface support steel rollers that the glass is pulled along after leaving the tin bath. These rollers may create scratches in the bottom glass surface. Some of the defects in the steel rollers may be caused by pieces of glass in the cut off process.

### Example II

An abrasion resistant non-brittle coating solution is prepared as in Example I, except titanium iso-propoxide, Ti(OC₃H₇)₄, was used instead of titanium ethoxide. The abrasion resistance and the strength results were virtually similar.

### Example III

A number of coating solutions were prepared as in Example I, except zirconium and aluminum alkoxides, Zr(OC₃H₇)₄ and Al(OC₄H₉)₃, were used instead of titanium ethoxide Ti(OC₂H₅)₄.

### Example IV

100 grams of glycidoxypropyltrimethoxysilane is mixed with 100 grams of ethyl alcohol, C₂H₅OH. To this mixture 8 grams of water and 0.3 grams of nitric acid is added and stirred for 10 minutes. Then 40 grams of titanium isopropoxide, Ti(OC₃H₇) 4, and 5 grams of silicon ethoxide, Si(OC₂H₅)₄, is also added and stirred another 10 minutes, polymerizing them with the glycidoxypropyltrimethoxysilane. After this is done, 150 grams of water and 30 grams of ethanol is added to further polymerize the structure to higher molecular size as well as stripping most of the organic terminal bonds from the structure.

This solution was also coated on glass samples and tested for the strength and abrasion resistance. Similar results, as shown in Example 1, were obtained.

### Example V

The coating solution was prepared as in Example IV, except silicon was introduced from 3 grams of silicon methoxide, Si(OCH₃)₄. The results were similar to that of given in Example IV.

To investigate the effect of coating on the strength of glass as a function of glass thickness, a solution was prepared as in example IV and coated on float glass samples having various thicknesses. As the glass got thinner the efficacy of the coating increased. The coating increased the average strength of glass from 130 MPa to ˜250 MPa when the thickness was 3 mm, but it increased to over 300 MPa when the thickness was 2 mm.

### Example VI

The coating solution is prepared as in Example IV, except 3 grams of silicon methoxide, Si(OCH₃)₄ was used instead of silicon ethoxide, Si(OC₂H₅)₄. The results were similar to that given in Example IV.

### Example VII

The coating solution is prepared as in Example IV, except 4 grams of methyltrimethoxysilane, CH₃Si(OCH₃)₃, instead of silicon methoxide, is added along with titanium isopropoxide. The resultant coating on glass, not only strengthened, the glass similarly but it made it hydrophobic, thus providing an additional property and protection against water related staining and chemical effects.

### Example VIII

The coating solution is prepared as in Example IV, except instead of silicon ethoxide, 2 grams of dimethylmethoxychlorosilane, (CH₃)₂Si(OCH₃)Cl, was added along with titanium isopropoxide, Ti(OC₃H₇)₄. The resultant coating, not only strengthened the glass but, was also hydrophobic.

### Example IX

The coating solution is prepared as in Example IV. Hydrophobicity was introduced by adding 2 grams of commercially available fluorine compound in solution. The results of the strength increase was similar to Examples I & IV, except the coating had the additional property of being hydrophobic and oilophobic (oleophobic).

### Example X

The following Tables 1 and 2 provide additional experimental evidence that the use of the coating as provided herein (all coated examples are within the inventive coating) leads to an improvement in glass strength.

TABLE 1

| | Strength 2 mm glass [MPa] | | |
|---|---|---|---|
| Sample # | Uncoated | Coated | Difference |
| 2-1 | 157 | | |
| 2-2 | 159 | | |
| 2-3 | 266 | | |
| 2-4 | 178 | | |
| 2-5 | 79 | | |
| 2-6 | | 262 | |
| 2-7 | | 301 | |
| 2-8 | | 364 | |
| 2-9 | | 292 | |
| 2-10 | | 314 | |
| Averages | 167.8 | 306.6 | 82.7% |

TABLE 2

| | Strength 3 mm glass [MPa] | | |
|---|---|---|---|
| Sample# | Uncoated | Coated | Difference |
| 3-1 | 128 | | |
| 3-2 | 106 | | |
| 3-3 | 110 | | |
| 3-4 | 136 | | |
| 3-5 | 171 | | |
| 3-6 | | 213 | |
| 3-7 | | 227 | |
| 3-8 | | 283 | |
| 3-9 | | 311 | |
| 3-10 | | 246 | |
| Averages | 130.2 | 256 | 96.6% |

### Example XI

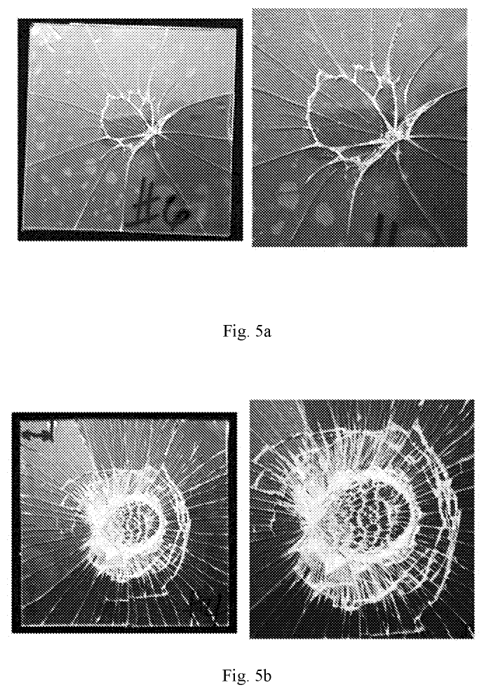

FIGS. 5a and 5b show an example of the strengthening of glass according to the present invention. The uncoated sample (FIG. 5a) displays a relatively moderate fracture pattern, which is a proof of relatively low energy needed for destruction. Here, a low force of about 79 MPa (about 11,600 psi) created the fracture pattern. On the contrary, the coated sample (FIG. 5b) displays a relatively significant fracture pattern, which is a proof of a relatively higher impact needed for destruction, and hence, for improved mechanical glass strength. Here, a higher force of about 364 MPa (about 53,000 psi) was necessary. The surface coating was approximately 2.4 microns thick.

### Example XII

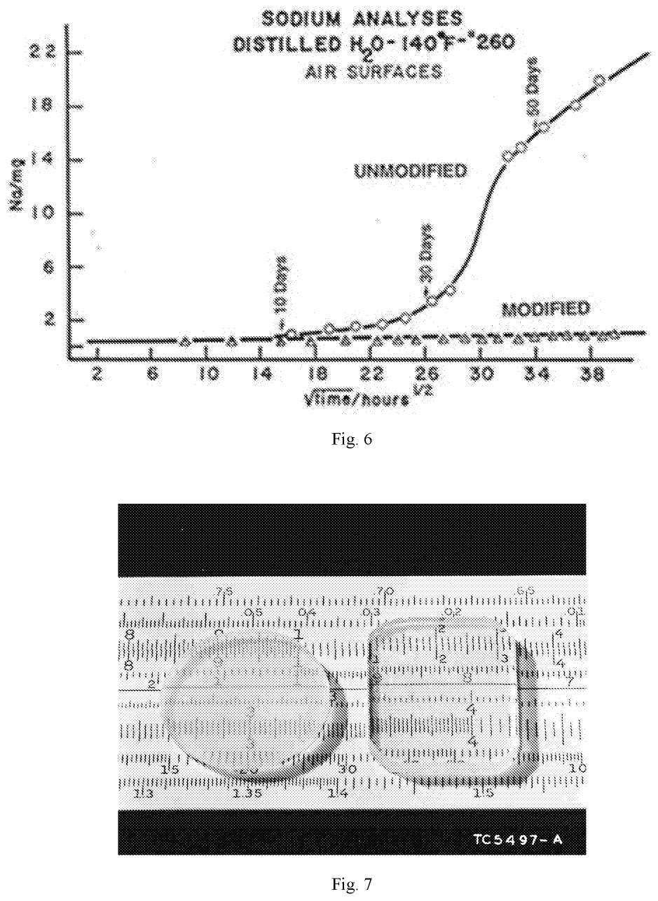

FIG. 6 is a dealkalization analysis of (sodium) of coated and uncoated glass whereby the coating takes terminated silica hydroxyl bond-Si—OH, and after the reaction now bridges the oxygen with boron —O—B—O— instead of e.g. —O—Si—O—. The graphs show an accumulated sodium leach from 4.5″×4.5″ clear float glass samples immersed in 250 cc H₂O at 60° C. (140° F.). As can be seen from the graphs, essentially no sodium leaches out from the modified (coated) surface contrary to uncoated glass.

### Example XIII

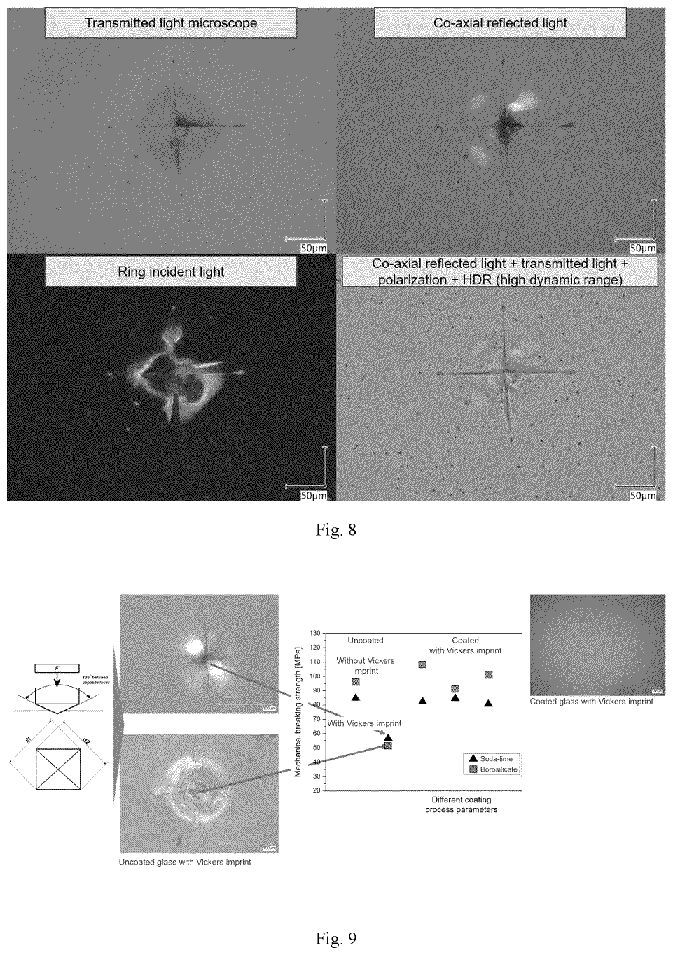

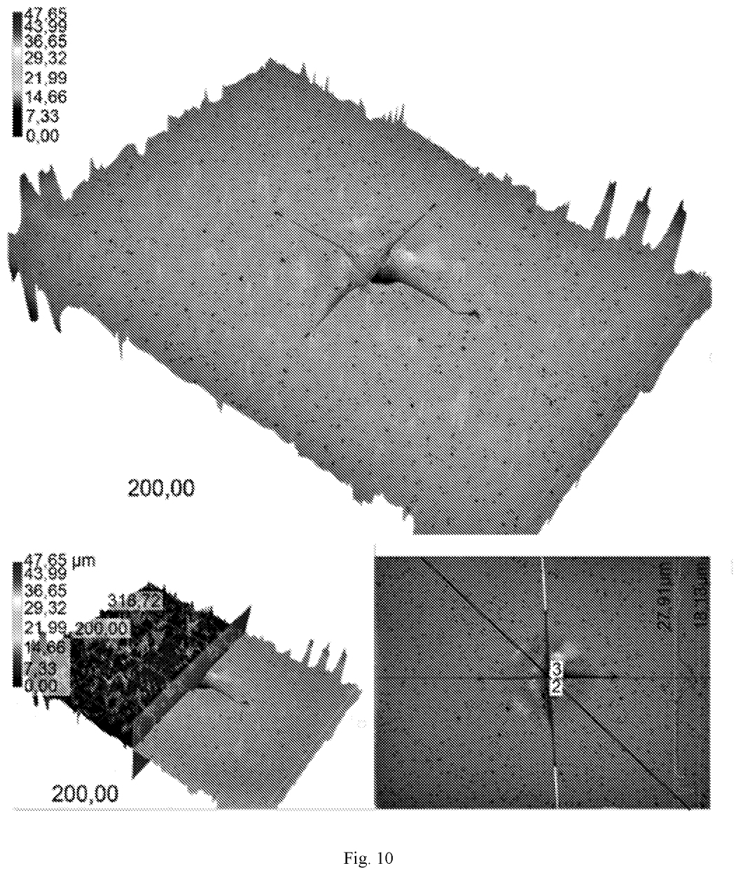

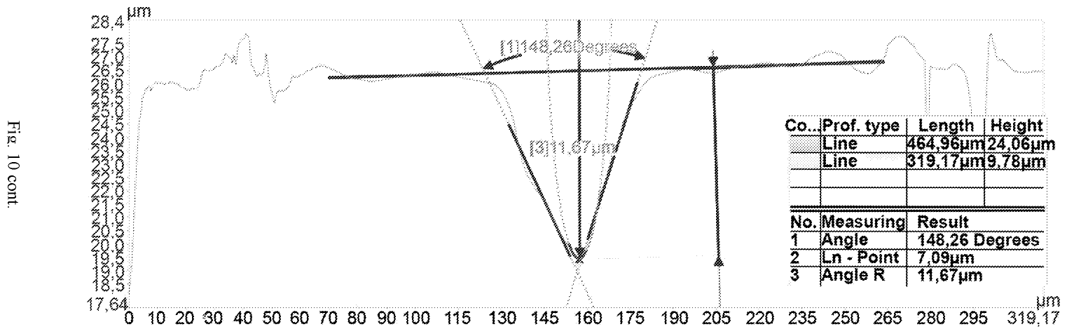

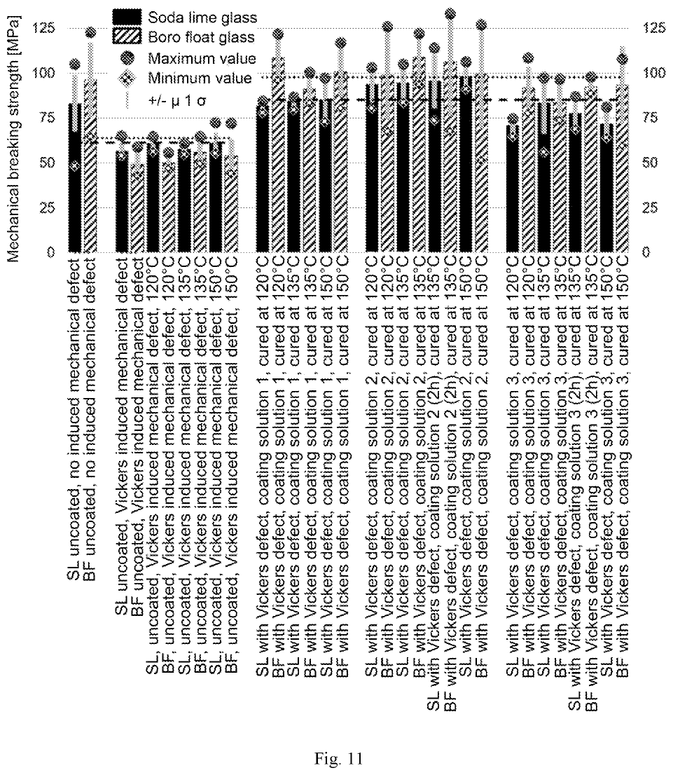

A glass surface mechanically damaged using the Vickers imprint method using 10-20 N results in severe surface damage on the glass (FIG. 8 shows a soda-lime float glass probe—that has intentionally been mechanically damaged with a Vickers imprint—under different lighting conditions with a microscope). A coating solution of the present invention is then applied to the glass surface. Upon coating a curing takes place for less than 60 minutes at temperatures of more than 30° C. FIG. 9 shows a soda-lime and a boro-silicate glass sample with the Vickers imprint without coating on the left and a soda-lime glass with coating after the Vickers imprint on the right, furthermore, the average values of the breakage test results. FIG. 10 illustrates a detailed analysis of the surface structure of the Vickers imprint. The top view shows the morphology of the Vickers imprint on a computer animated digital 3-D image from the digital microscope. On the middle left part, a vertical plane signifies the analyzed plane in which the imprint angle has been analyzed as shown on the bottom part (here: the vertical and horizontal scale are different). The V-angle of the Vickers imprint is 148.26°, and the depth of the Vickers imprint is 11.67 μm. The middle right part is the same image as the bottom right image of FIG. 8.

As can be seen in FIG. 9, the previous damage cannot be seen with the naked eye, and even under microscope, the previous damage is hardly visible. In addition, the mechanical strength of glass returns to the level of the original values of undamaged glass, less than 10% less that the original undamaged uncoated glass, and in some cases even to higher values compared to the original undamaged glass. FIG. 11 outlines detailed values for the breakage tests (1) for uncoated glass without mechanically induced defects, (2) for uncoated glass with mechanically induced defects (partly treated at different temperatures), and (3) for glass samples with mechanically induced defects that has been coated after the application of the defects (coating solution 1: glycidoxypropyltrimethoxysilane, EtOH, H₂O, Ti(OC₂H₅)+; coating solution 2: glycidoxypropyltrimethoxysilane, EtOH, Si(OCH₃)₄, H₂O, Ti(OC₂H₅)₄; coating solution 3: glycidoxypropyltrimethoxysilane, EtOH, B(OCH₃)₃, H₂O, Ti(OC₂H₅)₄; all in amounts as disclosed herein), and exposed to different temperatures.

As can be seen in FIG. 11, the process to heal the mechanically induced surface defects was as follows: (1) A set of samples with no damages were tested for mechanical breakage. (2) A set of samples were pre-damaged with a Vickers imprint but not coated, then either kept at room temperature or heat treated for 30 minutes at 120° C., 135° C., or 150° C. before exposing them to mechanical breakage test. (3) All other samples have been first pre-damaged with a Vickers imprint, and then coated with different solutions (recipes) before exposing them to mechanical breakage test. Tables 1 through 3 in the attachment show the general recipes of solutions (recipes) 1, 2, and 3 used in the testing. After mixing any of the solutions 1 through 3, the samples were exposed to curing temperatures of 120, 135, or 150° C. as outlined. For solutions 2 and 3 and for 135° C., the solution was coated to the glass substrate 2 hours after the solutions have been mixed.

1. Method for preparing coatings for improving glass strength and fracture toughness of glass, the method comprises mixing
a) a composition comprising 5-95 wt. % of one or more alkoxysilane(s) of the general formula
RₓSi(OR¹)₄₋ₓ
with up to 40 wt. % one or more metal or metalloid oxide(s) and/or one or more metal or metalloid alkoxide(s) in the presence of up to 20 wt. % water and up to 95 wt. % of an alcohol and up to 1 wt. % of a catalyst, wherein R is an organic radical, R¹ is independently selected from hydrogen and C₁₋₁₈ alkyl, or isomers or polyvalences thereof, and x is an integer from 0 to 3;
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
wherein the weight percentage of a), b), c) and the mixture thereof, respectively, adds up to 100 wt. %.

2. Method for preparing coatings for improving glass strength and fracture toughness of glass, the method comprises mixing
a) a composition comprising up to 25 wt. % of one or more metal or metalloid oxide(s) and/or one or more metal or metalloid alkoxide(s) in the presence of up 4 to 20 wt. % water and 60-95 wt. % of an alcohol;
b) a composition comprising 5-95 wt. % of one or more alkoxysilane(s) of the general formula
RₓSi(OR¹)₄₋ₓ
wherein R is an organic radical, R¹ is independently selected from hydrogen and C₁₋₁₈ alkyl, or isomers or polyvalences thereof, and x is an integer from 0 to 3, 5-70 wt. % of an alcohol, up to 20 wt. % water and up to 0.5 wt. % of a catalyst; and
c) a composition comprising 10-50 wt. % one or more metal or metalloid oxide(s) and/or one or more metal or metalloid alkoxide(s), 10-90 wt. % water and up to 100 wt. % of an alcohol;
wherein the weight percentage of a), b), c) and the mixture thereof, respectively, adds up to 100 wt. %.

3. The method according to claim 1, wherein the catalyst is nitric acid, aqua regia or hydrofluoric acid or a combination thereof.

4. The method according to claim 1, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof; R is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

5. The method according to claim 1, wherein the one or more alkoxysilane(s) is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

6. The method according to claim 1, wherein the one or more metal or metalloid oxide(s) and/or the one or more metal or metalloid alkoxide(s) are selected from oxides and/or alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.

7. The method according to claim 1, wherein the one or more alkoxysilane is β-glycidoxypropyltrimethoxysilane or γ-glycidoxypropyltrimethoxysilane and the one or more metal or metalloid alkoxide is selected from boron alkoxides, titanium alkoxides and silicon alkoxides or mixtures thereof.

8. A coating prepared Coating prepare by the method according to claim 1 any of claims 1 to 7.

9. A coating on a substrate Coating comprising a mixture of
a) a composition comprising 50-85 wt. % of one or more alkoxysilane(s) of the general formula
RₓSi(OR¹)₄₋ₓ
with up to 35 wt. % one or more metal or metalloid oxide(s) and/or one or more metal or metalloid alkoxide(s) in the presence of up to 10 wt. % water and up to 30 wt. % of an alcohol and up to 1 wt. % of a catalyst, wherein R is an organic radical, R′ is independently selected from hydrogen and C₁₋₁₈ alkyl, or isomers or polyvalences thereof, and x is an integer from 0 to 3; 11
b) a composition comprising 20-100 wt. % of one or more metal or metalloid oxide(s) and/or one or more metal or metalloid alkoxide(s), up to 80 wt. % of an alcohol, up to 20 wt. % water and up to 1 wt. % of a catalyst; and
c) a composition comprising up to 50 wt. % one or more metal or metalloid oxide(s) and/or one or more metal or metalloid alkoxide(s), up to 100 wt. % water and up to 100 wt. % of an alcohol;
wherein the weight percentage of a), b), c) and the mixture thereof, respectively, adds up to 100 wt. %.

10. A method Use of forming on a glass surface the coating according to claim 8 for improving glass strength and fracture toughness of glass, wherein glass strength and fracture toughness is improved by healing cracks in the surface of the glass.

11. A method Use of forming on a glass surface the coating according to claim 8 for repairing damaged silica containing materials.

12. The method according to claim 11, wherein the silica containing materials comprise glass, ceramic, glass ceramic, quartz, cement, concrete, and any other material containing silica.

13. The method according to claim 10, wherein one or more further coatings are applied for improving abrasion-resistance, chemical resistance, birefringence, modification of the index of refraction, increase hardness, protection of photovoltaic or semiconductor devices from potential induced degradation, control of increase in mechanical strength, repelling water by improving hydrophobicity, improving oleophobicity, protection against staining, weathering and/or harm deriving from energy release at the breakage force point, enabling fungicide, antibacterial and/or antiviral properties.

14. The method according to claim 1, wherein the one or more coatings are applied by dip coating, spray coating, vapor deposition, nebulizing, plasma outside deposition, chemical vapor deposition, plasma induced vapor deposition, soakage, soaking, suspension, and/or plasma enhanced vapor deposition.

15. The method according to claim 10, wherein the one or more coatings are applied in a controlled atmosphere by pressures below or above atmospheric pressure and/or at temperatures above or below atmospheric temperature.

16. The method according to claim 15, wherein the controlled atmosphere comprises conditioned air, an industrial gas or specialty gas with a dew point below −20° C. (253 K), at or below −50° C. (223 K), at or below −78.5° C. (194,7 K), at or below-195,8° C. (77,35 K), at or below 27 K, or at 4 K.

17. (canceled)

18. The method according to claim 15, wherein the pressure comprises an absolute pressure of 950 hPa, below 500 hPa, below 100 hPa, below 10 hPa, below 1 hPa, below 0.1 Pa, less than 10-6 Pa, or even less than 10-9 Pa.

19. The method according to claim 10, wherein unused coating is removed from the glass surface or the silica containing material.

20. The method according to claim 10, wherein the unused coating is removed by dipping the coated glass or the coated silica containing material into or rinsing the coated glass or the coated silica containing material with a solvent.

21. The method according to claim 10, wherein the improvement in glass strength is between 50 to 5000%, above 5000% or above 10000%.

22. The method according to claim 10, wherein devitrification is avoided.

23. The method according to claim 11, wherein the damage is induced by physical and/or chemical impact.

24. The method according to claim 10, wherein prior to applying the coating the glass surface, optionally including the edges, is pretreated with fluoric acid, with mechanical edge grinding, with flame polishing, with laser treatment and/or with any other edge treatment technology.

25. The method according to claim 10, wherein prior to applying the coating the glass is exposed to a temperature of at least 300 K below the transformation temperature (T_{g}).

26. The method according to claim 10, wherein a temperature of at least 30° C. is applied to the coated glass or the coated silica containing material for curing.

27. The method according to claim 10, wherein the coated glass or the coated silica containing material is exposed to waves of suitable frequency and/or wavelength comprising subsonic, sonic, supersonic, infrared, visible range, ultraviolet range, extreme ultraviolet range, and/or lower wavelengths than extreme ultraviolet range, and/or any other suitable frequency and/or wavelength triggering the desired reaction between the reacting partners depending on the physical properties, either frequency to enable curing of the coating to the glass substrate.

28. The method according to claim 10, wherein the coated glass or the coated silica containing material is exposed to tempering prior to or after coating.

29. The method according to claim 10, wherein prior to the application of the coating the glass in a molten state is stretched immediately following a hot-forming process for creating thinner glass.

30. The method according to claim 11, wherein the silica containing material is in the form of a porous material or powder that is soaked with the coating partly or entirely throughout the pores or within the porous material or powder cluster, within the prepreg, whether or not prepressed or exposed to temperatures materially above room temperature prior to soaking or soakage.

31. Glass product or product made from silica containing material prepared by the method of claim 10.

32. The method according to claim 2, wherein the catalyst is nitric acid, aqua regia or hydrofluoric acid or a combination thereof.

33. The method according to claim 2, wherein R is selected from C₁₋₁₈ alkyl, C₁₋₁₈ heteroalkyl, C₁₋₁₈ alkoxy, C₂₋₁₈ alkene, phenyl, R²—(CH₂)ₙ—, and R²—O—(CH₂)ₙ, or isomers or polyvalences thereof; R¹ is a C₁₋₁₈ alkyl, or isomers or polyvalences thereof, R² is independently selected from hydrogen, C₁₋₁₈ alkyl, (C₂H₄O)—(R³)ₘ—, C₂₋₁₈ alkene, or isomers or polyvalences thereof; R³ is independently selected from C₁₋₁₈ alkyl, or isomers or polyvalences thereof; n is an integer from 0 to 10; and m is an integer from 0 to 10.

34. The method according to claim 2, wherein the one or more alkoxysilane(s) is selected from β-glycidoxypropyltrimethoxysilane, γ-glycidoxypropyltrimethoxysilane, γ-methacryloxypropylsilane, methoxyethylsilane, methyltrimethoxysilane, dimethyldimethoxysilane, trimethylmethoxysilane, ethyltrimethoxysilane, diethyldimethoxysilane, and triethylmethoxysilane.

35. The method according to claim 2, wherein the one or more metal or metalloid oxide(s) and/or the one or more metal or metalloid alkoxide(s) are selected from oxides and/or alkoxides of boron, aluminum, gallium, indium, thallium, silicon, germanium, tin, lead, titanium, zirconium, hafnium, vanadium, niobium, tantalum, chromium, molybdenum, tungsten, copper, silver, gold, palladium, platinum, zinc, cobalt, rhodium, iridium, selenium, tellurium, and polonium.

36. The method according to claim 2, wherein the one or more alkoxysilane is β-glycidoxypropyltrimethoxysilane or γ-glycidoxypropyltrimethoxysilane and the one or more metal or metalloid alkoxide is selected from boron alkoxides, titanium alkoxides and silicon alkoxides or mixtures thereof.
